(19) United States
(12) Patent Application Publication
(10) Pub. No.: US 2017/0064963 A1
(43) Pub. Date: Mar. 9, 2017

(54) CHEMICAL INACTIVATION OF BACILLUS ANTHRACIS SPORES IN SOIL

(71) Applicants: U.S. ENVIRONMENTAL PROTECTION AGENCY, Washington, DC (US); BATTELLE MEMORIAL INSTITUTE, Columbus, OH (US)

(72) Inventors: Joseph P. WOOD, Cary, NC (US); Morgan Q.S. WENDLING, Worthington, OH (US); Andrew LASTIVKA, Columbus, OH (US)

(73) Assignees: U.S. ENVIRONMENTAL PROTECTION AGENCY, Washington, DC (US); BATTELLE MEMORIAL INSTITUTE, Columbus, OH (US)

(21) Appl. No.: 15/271,946

(22) Filed: Sep. 21, 2016

Related U.S. Application Data
(63) Continuation-in-part of application No. 14/282,981, filed on May 20, 2014, now abandoned.

(51) Int. Cl. A01N 59/02; A01N 59/00

(52) U.S. Cl. CPC A01N 59/02; A01N 59/00

(57) ABSTRACT

A method of inactivating B antracis spores in a contaminated target environment by: exposing the environment containing said spores to an effective amount of persulfate in solution and an oxidation agent, and allowing the persulfate solution and oxidation agent to remain in contact with the environment containing said spores for sufficient time to inactivate the spores.

### CROSS-REFERENCE TO RELATED APPLICATIONS

This application is a continuation-in-part of U.S. application Ser. No. 14/282,981, filed May 20, 2014 in the U.S. Patent and Trademark Office. All disclosures of the document named above are incorporated herein by reference.

### BACKGROUND OF THE INVENTION

1. Field of the Invention

The invention relates to the field of soil decontamination.

2. Description of the Related Art

Anthrax is a serious infectious disease caused by gram-positive, rod-shaped bacteria known as Bacillus anthracis. B. anthracis can be found naturally in soil and commonly affects domestic and wild animals around the world. Although it is rare in the United States, people can get sick if they come in contact with infected animals or contaminated animal products. Contact with B. anthracis can cause severe illness in both humans and animals. Domestic and wild animals such as cattle, sheep, goats, antelope, and deer can become infected when they breathe in or ingest spores in contaminated soil, plants, or water. In areas where domestic animals have had anthrax in the past, routine vaccination can help prevent outbreaks. B anthracis spores can remain capable of causing disease for years. Upon intake into a live host they may revert to vegetative forms and cause disease. B. anthracis spores in soil, even under drying conditions that would not support the vegetative forms of bacteria, can remain alive and capable of causing infection when inhaled and exposed to body moisture and temperatures.

While the vegetative form of B. Anthracis is easily killed by usual means of disinfection, the spores are extremely resistant to attempts to kill them. Because these spores are so resistant to attempts to kill them by usual means, a new methods are needed to decontaminate contaminated materials, including soil.

This invention provides means for the decontamination of soil contaminated with B. anthracis spores. Contamination of soil may be due to an intentional release of B. anthracis spores (e.g., a terrorist attack), or due to natural causes such as shedding of the bacteria from infected livestock. The bacteria will form spores, which can contaminate the soil for years and can cause anthrax in any possible host that might inhale the spores. This invention could also be used to decontaminate soil contaminated with other lethal microbial threat agents and prions. The invention may also be used to inactivate (kill) bacterial spores on other outdoor materials known to be difficult to treat or decontaminate, such as various types of concrete or wood. B. Anthracis spores have been used as a weapon around the world for nearly a century. In 2001, powdered B. anthracis spores were deliberately put into letters that were mailed through the U.S. postal system. Twenty-two people, including 12 mail handlers, got anthrax, and five of these 22 people died. Hence, finding new means of decontamination of environments contaminated with the spores is of utmost importance.

The invention was prompted by a need to decontaminate soil materials in the event of a wide area release of B. anthracis spores. The materials with which bacterial spores are associated greatly impacts a decontaminant's ability to inactivate the microorganism. Soil materials are very difficult to decontaminate, primarily due to their organic content and porosity. Organic matter in the soil consumes the oxidative ability of typical B. anthracis chemical decontaminants (such as bleach) that is needed to kill the anthracis spores, rendering these decontaminants useless. Sodium persulfate, used in combination with chemical activators such as hydrogen peroxide, is known to maintain its oxidative ability in soil environments and is used to remediate soils that are contaminated with organic pollutants. When tested for use to decontaminate materials, including soil, it was found that this chemical technology, when used in the manner disclosed herein, is effective for destroying B. anthracis spores in soil. Parametric tests were carried out to determine quantities, application rates, and contact times needed to inactivate the B. anthracis spores in a soil environment.

The only method we are aware of that has been demonstrated to be capable of inactivating B. anthracis spores in a soil matrix is chlorine dioxide gas. See EPA/600/R/12/517 April 2012, Inactivation of Bacillus anthracis Spores in Soil Matrices with Chlorine Dioxide Gas. The invention described herein provides a valuable alternative means for killing the spores.

### SUMMARY OF THE INVENTION

It is the purpose of this invention to provide a method for the inactivation of B. anthracis spores in soil contaminated therewith comprising contacting the contaminated environment containing the spores with an effective amount of a persulfate and an activator (e.g., hydrogen peroxide, ferrous ions) for a time sufficient to inactivate substantially all of the B. anthracis spores in the substrate containing said spores. The method for the inactivation of B. anthracis spores in soil contaminated comprises contacting the soil with an effective amount of a persulfate and an oxidation activator for a time sufficient to inactivate substantially all of the B. anthracis spores contained therein. A preferred oxidation agent is hydrogen peroxide.

Additional aspects and/or advantages of the invention will be set forth in part in the description which follows and, in part, will be obvious from the description, or may be learned by practice of the invention.

### DETAILED DESCRIPTION OF THE EMBODIMENTS

The present invention provides a means, using a combination of a persulfate and an activator, to effectively inactivate substantially all of the B. anthracis spores in a soil contaminated therewith, provided that contact between the contaminated soil and an effective amount of the composition is maintained for a sufficiently long period of time.

The persulfate and activator may be applied to the soil simultaneously or sequentially. When applied sequentially, either the persulfate or oxidation activator (hydrogen peroxide being a preferred activator) may be applied first followed by the other or may be applied simultaneously in a single solution. The order of application is not important.

Although it is known that a composition comprising a persulfate and hydrogen peroxide is effective for oxidizing volatile organic compounds contained in soil (see U.S. Pat. No. 7,524,141, which is incorporated herein in its entirety by reference), the fact that such a composition would also be effective for inactivating B. anthracis spores in a soil contaminated by B anthracis spores was not anticipated or suspected at the time of the invention of U.S. Pat. No. 7,524,141, because the problems encountered in remediation problems addressed in that patent are entirely different from those addressed in this application. The discovery that that persulfates are efficacious for the inactivation of B. anthracis spores in soils as varied as topsoil and Arizona Test Dust (AZDT) was quite unexpected.

Decontamination efficacy was determined based on the log reduction (LR) in viable spores recovered from the inoculated samples, with and without exposure to the decontaminant

For the sodium persulfate tests, a contact time of seven days was used for each test (Table 1). For each test listed below, separate subtests were conducted for each combination of microorganism and soil type.

As is disclosed herein, the use of the method described herein is efficacious for the inactivation of B. anthracis spores in soils as varied as topsoil and Arizona Test Dust (AZDT). Decontamination efficacy was determined based on the log reduction (LR) in viable spores recovered from the inoculated samples, with and without exposure to the decontaminant.

For the sodium persulfate tests, a contact time of seven days was used for each test (Table 1). For each test listed below, separate subtests were conducted for each combination of microorganism and soil type.

TABLE 1
Sodium Persulfate Klozur ™ Test Matrix

| | | | Application Fequency* | Contact |
|---|---|---|---|---|
| | Biological | Soil | (total number of | Time |
| Test # | Agent | Type | applications) | (days) |
| 1 | B. anthracis | Topsoil | Every 60 minutes (6) | 7 |
| | B. subtilis | AZTD | | |
| 2 | B. anthracis | Topsoil | Every 60 minutes (3) | 7 |
| | B. subtilis | AZTD | | |
| 3 | B. anthracis | Topsoil | Days 0, 2 and 4 (3) | 7 |
| | B. subtilis | AZTD | | |
| 4 | B. anthracis | Topsoil | Time 0 and 1 Hr (2) | 7 |
| | B. subtilis | AZTD | | |
| 5 | B. anthracis | Topsoil | Day 0 (1) | 7 |
| | B. subtilis | AZTD | | |

* = Each application consisted of 1 mL Klozur ™ followed by 1 mL 8% H₂O₂.

The B. anthracis spores used for this testing were prepared from a qualified stock of the Ames strain at the Battelle Biomedical Research Center (BBRC, West Jefferson, Ohio). All spore lots were subject to a stringent characterization and qualification process. Specifically, all spore lots were characterized prior to use by observation of colony morphology, direct microscopic observation of spore morphology and size and determination of percent refractivity and percent encapsulation (of the vegetative bacterial colonies). In addition, the number of viable spores was determined by colony count and expressed as colony forming units per milliliter (CFU/mL). Theoretically, once plated onto bacterial growth media, each viable spore germinates and yields one CFU. Variations in the expected colony phenotypes were recorded. Endotoxin concentration of each spore preparation was determined by the Limulus Amebocyte Lysate (LAL) assay to assess whether contamination from gram-negative bacteria occurred during the propagation and purification process of the spores. Genomic deoxyribonucleic acid (DNA) was extracted from the spores and DNA fingerprinting by polymerase chain reaction (PCR) was performed to confirm the genotype. The virulence of the spore lot was measured by challenging guinea pigs intradermally with a dilution series of spore suspensions, and virulence was expressed as the intradermal median lethal dose

To ensure spores are used in testing (and not vegetative cells), various steps are taken, described as follows. The spore stock is stored in purified water and characterized via visual purity. The stock is viewed under the microscope, viable spores are then counted and any cell debris is noted. The spore preparation must have a minimum 95% purity vs. debris and non-viable spores. The spore prep is also heat shocked prior to removing from the fermenter. In addition, testing was conducted for robustness of the spores via hydrochloric acid (HCl) resistance.

The B. subtilis spores (BBRC stock culture; American Type Culture Collection [ATCC] 19659) underwent the same characterization tests as described above for B. anthracis, except that the LAL assay, DNA fingerprinting, and virulence testing were excluded. Qualitative PCR was performed using a custom PCR assay to confirm B. subtilis. Primers were designed that targeted a conserved region of B. subtilis chromosomal DNA because multiple strains of this bacterium exist.

The stock spore suspensions were prepared in SFW at an approximate concentration of 1×1 CFU/mL and stored under refrigeration at 2 to 8 degrees Celsius (° C.).

Information on the soil types used for testing is presented in Table 2. Soil samples were placed unpacked in one ounce (oz), 1.5 inch diameter glass jars (Qorpak®, #GLC-O 1596, Bridgeville, Pa.) at a depth of one cm for testing. The commercial topsoil used for this evaluation was a proprietary mixture of soil, composted cow manure, sand, and other ingredients (also proprietary). Topsoil was selected for testing since it represents a difficult soil to treat in terms of its organic content. The AZTD was selected for testing since it represents a soil with minimal organic burden.

Soils used in the tests were prepared for testing by sterilization via gamma irradiation at 40 kilogray (kGy; STERIS Isomedix Services, Libertyville, Ill.). Soils were pre-sterilized to minimize contamination that could interfere with colony counting. In addition to gamma irradiation at ˜40 kGy, samples were gamma irradiated at ˜60 kGy or autoclaved at 121 ° C. for one hr. Gamma-irradiated soils were sealed in Lock & Lock containers (Farmers Branch, Tex.) and autoclaved soils were sealed in sterilization pouches (Cat # 01-812-51, Fisher Scientific, Pittsburgh, Pa.) to preserve sterility until the samples were ready for use.

TABLE 2
Soil Materials

| | | | Pre- | Pre- |
|---|---|---|---|---|
| | | | sterilized | sterilized |
| | Lot, Batch, or | | moisture | organic |
| | ASTM No., or | Manufacturer/ | content | carbon |
| Material* | Observation | Supplier Name | (%) | content (%) |
| Topsoil | Earthgro ® | The Scotts | 34 | 9.3 |
| | Topsoil, | Company | | |
| | Product #: | Marysville, OH | | |
| | 71140180 | | | |
| Arizona | ISO 12103-1, A3 | Powder | 0.23 | 0.40 |
| Test Dust | Medium | Technology, Inc. | | |
| | | Burnsville, MN | | |

*A soil sample consisted of a 1.5 in diameter glass jar filled with uncompacted soil to a height of 1 cm.

Prior to decontamination testing, samples (pre- and post-sterilization) were analyzed in triplicate using ASTM D Method 2974-8 7 for Moisture, Ash and Organic Matter of Peat and Other Organic Soils. The topsoil had a much higher moisture and organic content compared to the AZTD. The moisture and organic content did not change significantly after the gamma irradiation of the samples. However, slight changes were observed in autoclaved samples.

Test and positive control soil samples (in their jars) were placed on a flat surface within a Class II biological safety cabinet (BSC) and inoculated with approximately 1×10⁸ CFU of viable B. anthracis spores per sample. A 100 microliter aliquot of a stock suspension of approximately 1×10⁹ CFU/mL was dispensed using a micropipette applied as 10 μL droplets across the soil surface. This approach provided a more uniform distribution of spores across the sample surface than would be obtained through a single drop of the suspension. After inoculation, the samples were left undisturbed overnight in a Class III BSC to dry under ambient conditions, approximately 22° C. and 40% relative humidity (RH). A heat shock test was conducted to confirm that no germination of cells occurred (only spores present) while spores were left in soil samples overnight.

The number and type of replicate samples used for each combination of material, decontaminant, concentration, and environmental condition included were:
five test samples (inoculated with B. anthracis spores and exposed to decontaminant)
five positive controls (inoculated with B. anthracis spores but not exposed to decontaminant)
one laboratory blank (inoculated with sterile water only and not exposed to the decontaminant)
one procedural blank (inoculated with sterile water only and exposed to the decontaminant)

On the day following spore inoculation, the jars of soil samples intended for decontamination (including blanks) were transferred into a test chamber where the decontamination technology was applied using the apparatus and application conditions specified below.

At the appropriate decontaminant contact time, spores were extracted from the soil samples by adding 10 mL of sterile phosphate-buffered saline extraction buffer containing 0.1% Triton® X-100 surfactant (PBST; Sigma, St. Louis, Mo.) and neutralizer (to stop sporicidal activity when liquid decontaminant was used to each sample jar. The jars were capped and agitated on an orbital shaker for 15 minutes at approximately 200 revolutions per minute (rpm) at room temperature.

Residual viable spores were quantified using a dilution plating approach. Following extraction, the extract was removed and a series of 10-fold dilutions was prepared in sterile water. An aliquot (0.1 mL) of either the undiluted extract and/or each serial dilution was plated onto tryptic soy agar in triplicate and incubated for 18-24 hours (hr) at 35-37° C. Colonies were counted manually and CFU/mL was determined by multiplying the average number of colonies per plate by the reciprocal of the dilution. Dilution data representing the greatest number of individually definable colonies were expressed as arithmetic mean ±standard deviation of the numbers of CFU observed.

Laboratory blanks controlled for sterility and procedural blanks controlled for viable spores inadvertently introduced to test samples. The blanks were inoculated with an equivalent amount of 0.1 mL SFW. The target acceptance criterion was that extracts of laboratory or procedural blanks were to contain zero CFU of target organism. After each decontamination test, the BSC III was cleaned thoroughly (using separate steps involving bleach, ethanol, water, than drying) following procedures established under the BBRC Facility Safety Plan.

The mean percent spore recovery from each soil sample was calculated using results from positive control samples (inoculated, not decontaminated), by means of the following equation:

Mean % Recovery=[Mean CFU_{pc}/CFUₛₚᵢₖₑ]×100 (1)

where Mean CFU_{pc} is the mean number of CFU recovered from five replicate positive control samples of a single material, and CFUₛₚᵢₖₑ is the number of CFU inoculated onto each of those samples. The value of CFUₛₚᵢₖₑ is known from enumeration of the stock spore suspension. Spore recovery was calculated for B. anthracis or B. subtilis on each soil sample, and the results set forth below.

The performance or efficacy of the decontaminants was assessed by determining the number of viable organisms remaining on each soil test sample after decontamination. Those numbers were compared to the number of viable organisms extracted from the positive control samples.

The number of viable spores of B. anthracis in extracts of test and positive control samples was determined to calculate efficacy of the decontaminant. Efficacy is defined as the extent (as logio reduction) to which viable spores extracted from test samples after decontamination were less numerous than the viable spores extracted from positive control samples. The logarithm of the CFU abundance from each sample extract was determined, and the mean of those logarithm values was then determined for each set of control and associated test samples, respectively. Efficacy of a decontaminant for a test organism/test condition on the i^{th} sample material was calculated as the difference between those mean log values, i.e.:

Efficacy=(log₁₀ CFUcᵢⱼ)−(log₁₀ CFUtᵢⱼ) (2)

where log₁₀ CFUcᵢⱼ refers to the j individual logarithm values obtained from the positive control samples, and log₁₀ CFUtᵢⱼ refers to the j individual logarithm values obtained from the corresponding test samples, and the overbar designates a mean value. In tests conducted under this plan, there were five positive controls and five corresponding test samples (i.e., j=5) for each soil sample. A decontaminant that achieves a 6 LR or greater is considered effective.

In the case where no viable spores were detected in any of the five test sample extracts after decontamination, a CFU abundance of 1 was assigned, resulting in a log₁₀ CFU of zero for that material. When this occurs, the spore population on the soil sample is considered to be completely inactivated within the detection limit of 33 CFU per soil sample. With complete spore inactivation, the decontaminant achieves the maximum efficacy possible or quantifiable. That is, the final efficacy on that material is reported as greater than or equal to (≧) the value calculated by Equation 2. With complete inactivation, the reported LR value is dependent on the positive control recovery, and in most cases, the LR≧7.5.

The variances (i.e., the square of the standard deviation) of the log₁₀ CFUcᵢⱼ and log₁₀ CFUtᵢⱼ values were also calculated for both the control and test samples (i.e., S²cᵢⱼ and S²tᵢⱼ), and were used to calculate the pooled standard error (SE) for the efficacy value calculated in Equation 2, as follows:

$$SE = \sqrt{\frac{{S}^{2} {c}_{ij}}{5} + \frac{{S}^{2} {t}_{ij}}{5}} \qquad ( 3 )$$

where the number 5 again represents the number j of samples in both the control and test data sets. Each efficacy result is reported as an LR value with an associated 95% confidence interval (CI), calculated as follows:

95% CI=Efficacy±(1.96×SE) (4)

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of inactivating B antracis spores in a contaminated target environment by:
a) exposing the environment containing said spores to an effective amount of persulfate in solution and an oxidation agent
b) allowing the persulfate solution and oxidation agent to remain in contact with the environment containing said spores for sufficient time to inactivate the spores.

2. The method of claim 1 wherein the oxidation agent is hydrogen peroxide.

3. The method of claim 1 wherein the persulfate is a sodium persulfate.

4. The method of claim 1 wherein a solution containing both an effective amount of sodium persulfate and hydrogen peroxide is administered to the target environment.

5. The method of claim 4 wherein the solution containing sodium persulfate and hydrogen peroxide is administered to the target environment as a spray.

6. The method of claim 4 wherein the target environment is transferred to the solution containing sodium persulfate and hydrogen peroxide.
